(19) United States
(12) Patent Application Publication
(10) Pub. No.: US 2016/0080255 A1
(43) Pub. Date: Mar. 17, 2016

(54) METHOD AND SYSTEM FOR SETTING UP ROUTING IN A CLUSTERED STORAGE SYSTEM

(71) Applicant: NETAPP, INC., Sunnyvale, CA (US)

(72) Inventors: James Andrew Ignatuk, Mars, PA (US); Jeffrey David Prem, Pittsburgh, PA (US); Jeffrey Eric Semke, Allison Park, PA (US)

(21) Appl. No.: 14/489,099

(22) Filed: Sep. 17, 2014

(51) Int. Cl. H04L 12/715; H04L 29/08; H04L 12/741

(52) U.S. Cl. CPC H04L 45/46; H04L 45/74; H04L 67/1097

(57) ABSTRACT

Methods and systems for setting up routing in a clustered storage system are provided. The method includes generating a global routing data structure having a plurality of default routes for a clustered storage system having a plurality of nodes; creating a logical interface for a virtual storage system presented to a client system for using storage space at the clustered storage system managed by one of the plurality of nodes; examining the global routing data structure by the plurality of nodes for adding a route for the logical interface when a gateway address of the route is on a same subnet as the logical interface; and storing the route in a routing data structure for the node that manages the logical interface for the virtual storage system.

### TECHNICAL FIELD

The present disclosure relates to communication in networked storage systems.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple users with access to shared data, backing up data and others.

A storage system typically includes at least one computing system executing a storage operating system for storing and retrieving data on behalf of one or more client computing systems (“clients”). The storage operating system stores and manages shared data containers in a set of mass storage devices.

Storage systems may include a plurality of nodes operating within a cluster for processing client requests. Each node may be connected to different networks or subnets to service clients at a plurality of physical sites. Internet Protocol (IP) addresses are typically provided or associated with a node and are used by client systems to access the cluster. Once an IP address is assigned, network routes are installed at the nodes to enable clients to access the cluster using the assigned IP address.

In conventional systems, a storage administrator is typically provided with a routing table per node. The storage administrator has to manually configure a routing table each time an IP address is hosted at the node. This becomes challenging especially if an IP address is migrated to another node because one has to manually track and create the routing table. Continuous efforts are being made for efficiently managing routing information in a clustered storage system.

### SUMMARY

In one aspect, a machine implemented method is provided. The method includes generating a global routing data structure having a plurality of default routes for a clustered storage system having a plurality of nodes; creating a logical interface for a virtual storage system presented to a client system for using storage space at the clustered storage system managed by one of the plurality of nodes; examining the global routing data structure by the plurality of nodes for adding a route for the logical interface when a gateway address of the route is on a same subnet as the logical interface; and storing the route in a routing data structure for the node that manages the logical interface for the virtual storage system.

In another aspect, a non-transitory, machine readable storage medium having stored thereon instructions for performing a method is provided. The machine executable code which when executed by at least one machine, causes the machine to: generate a global routing data structure having a plurality of default routes for a clustered storage system having a plurality of nodes; create a logical interface for a virtual storage system presented to a client system for using storage space at the clustered storage system managed by one of the plurality of nodes; examine the global routing data structure by the plurality of nodes for adding a route for the logical interface when a gateway address of the route is on a same subnet as the logical interface; and store the route in a routing data structure for the node that manages the logical interface for the virtual storage system.

In yet another aspect, a system having a memory containing machine readable medium comprising machine executable code having stored thereon instructions is provided. A processor module coupled to the memory is configured to execute the machine executable code to: generate a global routing data structure having a plurality of default routes for a clustered storage system having a plurality of nodes; create a logical interface for a virtual storage system presented to a client system for using storage space at the clustered storage system managed by one of the plurality of nodes; examine the global routing data structure by the plurality of nodes for adding a route for the logical interface when a gateway address of the route is on a same subnet as the logical interface; and store the route in a routing data structure for the node that manages the logical interface for the virtual storage system.

This brief summary has been provided so that the nature of this disclosure may be understood quickly. A more complete understanding of the disclosure can be obtained by reference to the following detailed description of the various thereof in connection with the attached drawings.

### BRIEF DESCRIPTION OF THE DRAWINGS

The foregoing features and other features will now be described with reference to the drawings of the various aspects. In the drawings, the same components have the same reference numerals. The illustrated aspects are intended to illustrate, but not to limit the present disclosure. The drawings include the following Figures:

FIGS. 1A-1B show examples of operating environments for the various aspects of the present disclosure;

FIG. 2A shows an example of a format used by the various aspects of the present disclosure for providing client access to a clustered storage system;

FIG. 2B shows a process flow diagram, according to one aspect of the present disclosure;

FIG. 3 is an example of a storage node used in the cluster of FIG. 1A, according to one aspect of the present disclosure;

FIG. 4 shows an example of a storage operating system, used according to one aspect of the present disclosure; and

FIG. 5 shows an example of a processing system, used according to one aspect of the present disclosure.

### DETAILED DESCRIPTION

As a preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

In one aspect, methods and systems for setting up routing in a clustered storage system with a plurality of nodes are provided. A global routing data structure for the cluster is generated with a plurality of default routes. A logical interface is created for a virtual storage system that is presented to a client system for using storage space at the clustered storage. The global routing data structure is then examined by the plurality of nodes for adding a route for the logical interface when a gateway address of the route is on a same subnet as the logical interface. The route is then stored in a routing data structure for the node that manages the logical interface for the virtual storage system.

Clustered System:

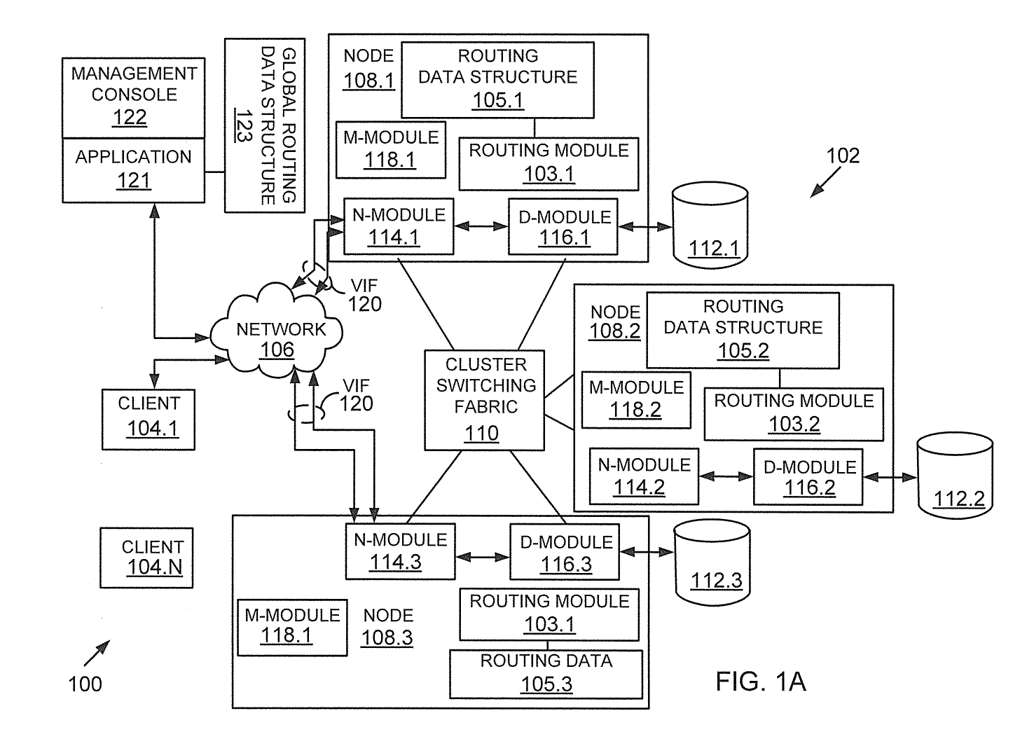

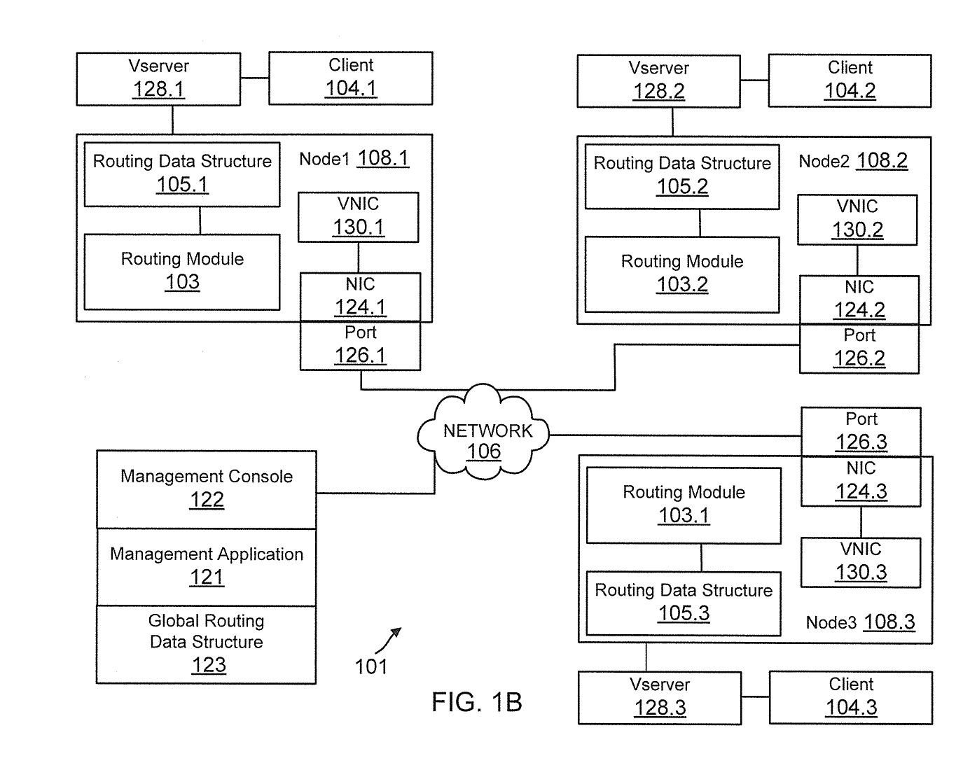

FIG. 1A shows a cluster based storage environment 100 (also referred to as “system 100”) having a plurality of nodes 108.1-108.3 operating in a cluster 102 where the various aspects disclosed herein can be implemented. The nodes 108.1-108.3 are interconnected by a switching fabric 110, which, for example, may be embodied as a switch or any other type of connecting device.

Storage environment 100 includes a plurality of client computing systems (also referred to as a client system or client) 104.1-104.N and at least a network 106 communicably connecting the client systems 104.1-104.N and the clustered storage system 102. Network 106 may be the Internet, a local area network, a wide area network, a metropolitan area network, a wireless network or any other network type.

Storage environment 100 further includes a management console 122 executing a management application 121 out of a memory. Management console 122 may be used to configure and manage various elements of system 100.

Each node 108.1-108.3 may be connected to different networks or subnets to service clients at a plurality of physical sites. Most networks today use the Transmission Control Protocol/Internet Protocol (TCP/IP) for network communication. In the TCP/IP protocol, an IP address is used as a network access address that uniquely identifies a computing device. As an example, there are two standards for IP addresses: IP Version 4 (IPv4) and IP Version 6 (IPv6). IPv4 uses 32 binary bits to create a single unique address on the network. An IPv4 address is expressed by four numbers separated by dots. Each number is the decimal (base-10) representation for an eight-digit binary (base-2) number, also called an octet, for example: 216.27.61.137.

IPv6 uses 128 binary bits to create a single unique address on the network. An IPv6 address is expressed by eight groups of hexadecimal (base-16) numbers separated by colons.

An IP address can be either dynamic or static. A static address is one that a user can configure. Dynamic addresses are assigned using a Dynamic Host Configuration Protocol (DHCP), a service running on a network. DHCP typically runs on network hardware such as routers or dedicated DHCP servers.

In one aspect, management application 121 is a provided with a global routing data structure 123 that stores all routes within cluster 102. The global routing data structure 123 is also provided to individual cluster nodes that execute a routing module 103.1-103.3 (also referred to as routing module 103). The routing module 103 analyzes the configuration data structure 123 and determines which route is applicable to a specific IP address that it hosts. The routing module 103 generates a node specific routing data structure, shown as 105.1-105.3 (also referred to as routing data structure 105).

When an IP address is migrated to another node, then the routing module at that node detects the IP address and updates the routing data structure 105. As described below in more detail, a storage administrator does not have to be concerned about IP address migration and instead the nodes of cluster nodes manage the IP addresses and the routing data structures that are associated with the IP addresses.

Each of the plurality of nodes 108.1-108.3 is configured to include an N-module, a D-module, and an M-Module, each of which can be implemented as a processor executable module. For example, node 108.1 includes N-module 114.1, D-module 116.1, and M-Module 118.1, node 108.2 includes N-module 114.2, D-module 116.2, and M-Module 118.2, and node 108.3 includes N-module 114.3, D-module 116.3, and M-Module 118.3.

The N-modules 114.1-114.3 include functionality that enable the respective nodes 108.1-108.3 to connect to one or more of the client systems 104.1-104.N over network 106 and with other nodes via switching fabric 110. The D-modules 116.1-116.3 connect to one or more of mass storage devices 112.1-112.3 (may also be referred to as storage device (s) 112). The M-Modules 118.1-118.3 provide management functions for the clustered storage system 102.

Although FIG. 1A depicts an equal number (i.e., 3) of the N-modules 114.1-114.3, the D-modules 116.1-116.3, and the M-Modules 118.1-118.3, any other suitable number of N-modules, D-modules, and M-Modules may be provided. There may also be different numbers of N-modules, D-modules, and/or M-modules within the clustered storage system 102. For example, in alternative aspects, the clustered storage system 102 may include a plurality of N-modules and a plurality of D-modules interconnected in a configuration that does not reflect a one-to-one correspondence between the N-modules and D-modules.

The mass storage devices 112 may include writable storage device media such as magnetic disks, video tape, optical, DVD, magnetic tape, non-volatile memory devices for example, self-encrypting drives, flash memory devices and any other similar media adapted to store information. The storage devices 112 may be organized as one or more groups of Redundant Array of Independent (or Inexpensive) Disks (RAID). The various aspects disclosed herein are not limited to any particular storage device or storage device configuration.

The storage system 102 provides a set of storage volumes to clients 104 for storing information at storage devices 112. A storage operating system executed by the nodes present or export data stored at storage devices 112 as a volume, or one or more qtree sub-volume units. Each volume may be configured to store data files (or data containers or data objects), scripts, word processing documents, executable programs, and any other type of structured or unstructured data. From the perspective of client systems, each volume can appear to be a single storage drive. However, each volume can represent the storage space in at one storage device, an aggregate of some or all of the storage space in multiple storage devices, a RAID group, or any other suitable set of storage space.

The storage system 102 may be used to store and manage information at storage devices 112 based on a client request. The request may be based on file-based access protocols, for example, the Common Internet File System (CIFS) protocol or Network File System (NFS) protocol, over the TCP/IP. Alternatively, the request may use block-based access protocols, for example, the Small Computer Systems Interface (SCSI) protocol encapsulated over TCP (iSCSI) and SCSI encapsulated over Fibre Channel (FCP).

A switched virtualization layer including a plurality of virtual interfaces (VIFs) 120 is provided to interface between the respective N-modules 114.1-114.3 and the client systems 104.1-104.N, allowing storage 112.1-112.3 associated with the nodes 108.1-108.3 to be presented to the client systems 104.1-104.N as a single shared storage pool.

In one aspect, the clustered storage system 102 can be organized into any suitable number of virtual servers (may also be referred to as “Vservers” or virtual storage machines). A Vserver is a virtual representation of a physical storage controller/system and is presented to a client system for storing information at storage devices 112.

Each Vserver represents a single storage system namespace with independent network access. Each Vserver has a user domain and a security domain that are separate from the user and security domains of other Vservers. Moreover, each Vserver is associated with one or more VIFs 120 and can span one or more physical nodes, each of which can hold one or more VIFs 120 and storage associated with one or more Vservers. Client systems can access the data via a Vserver from any node of the clustered system, through the VIFs associated with that Vserver.

Each client system may request the services of one of the respective nodes 108.1, 108.2, 108.3, and that node may return the results of the services requested by the client system by exchanging packets over the computer network 106, which may be wire-based, optical fiber, wireless, or any other suitable combination thereof. The client systems may issue packets according to file-based access protocols, such as the NFS or CIFS protocol, when accessing information in the form of files and directories.

FIG. 1B shows system 101 of using the routing data structure 105.1-105.3 by nodes 108.1-108.3, according to one aspect of the present disclosure. System 101 has various components that are similar to system 100 of FIG. 1A. System 101 includes a plurality of Vservers 128.1-128.3 that are presented to client systems 104.1-104.3, respectively. Each node has at least one network interface card (NIC) (or device) 124.1-124.3 with at least one physical port 126.1-126.3 that is used by the Vservers to connect with client systems 104.1-104.3. It is noteworthy that N-Module and D-modules of each node may have more than one NIC.

Ports 126.1-126.3 of each NIC include logic and circuitry to send and receive packets. The structure of the logic and circuitry is such that it allows the NICs to handle packets complying with one or more protocols, for example, Ethernet, Fibre Channel and others.

NIC 124.1-124.3 include a processing device, a receiving and transmitting segments that are used to process incoming and outgoing packets. Details regarding the structure of NICs 124.1-124.3 are not germane to the various aspects described herein and hence are not described.

Each Vserver 128.1-128.3 may be presented with a virtual NIC (VNIC) 130.1-130.3 for sending and receiving information to and from clients 104.1-104.3. Each VNIC is a virtual representation of the physical NIC and this allows multiple Vservers to share a same physical NIC.

Similar to FIG. 1A, FIG. 1B shows the routing data structure 105.1 as maintained by the routing module 103.1-103.3 of each node. The routing module may be implemented at a N-module, D-Module or M-module. The various aspects described herein are not limited to any specific entity implementing the routing module. The use of the global routing data structure 123 and the routing data structure 105 are described below in detail.

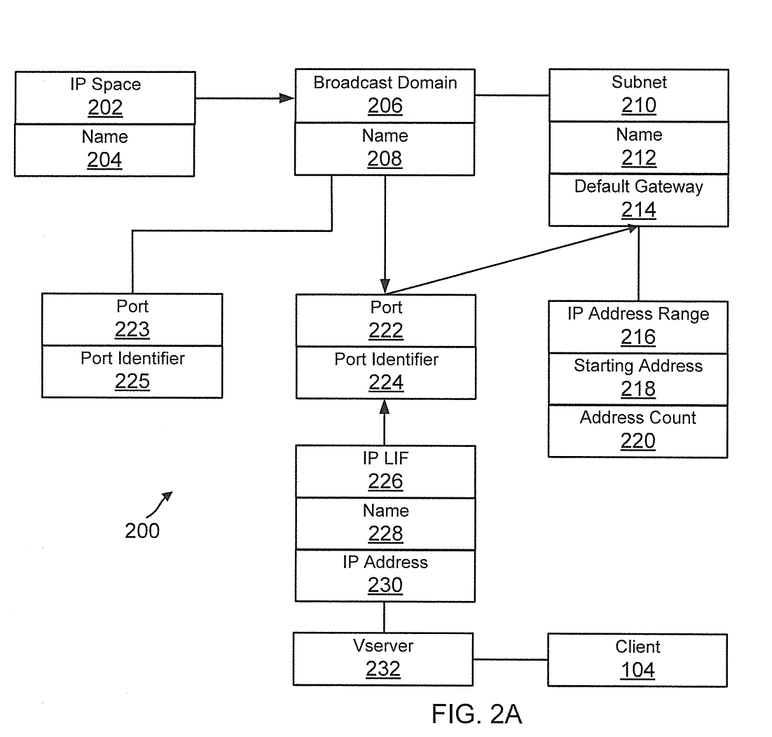

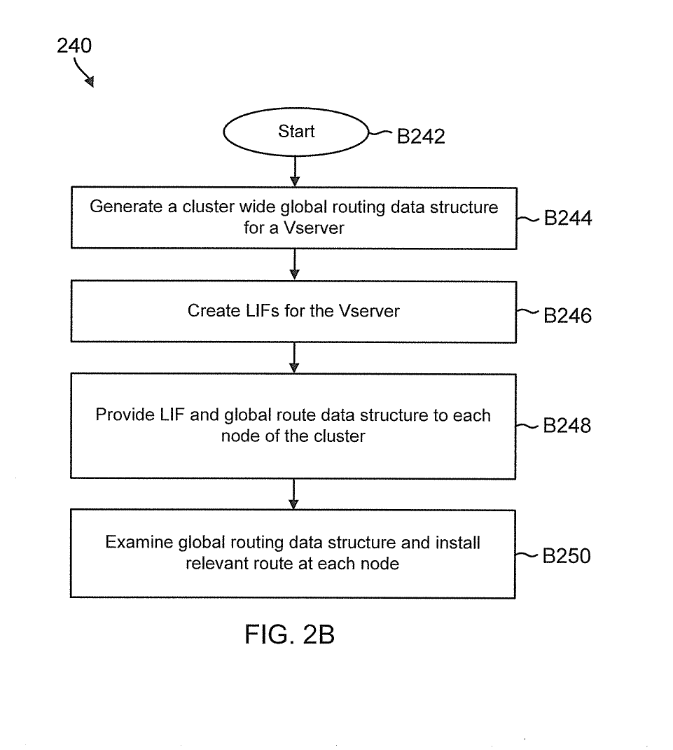

FIG. 2A shows an example of a layout 200 that is used by the clustered storage system for managing network addressing/routing, according to one aspect of the present disclosure. Layout 200 includes an IP address space 202 which is identified by a unique name 204. The IP address space 202 is an object that includes a plurality of unique IP addresses.

IP address space 202 owns or is associated with at least one broadcast domain 206 that is identified by a unique identifier 208. The broadcast domain 206 allows a user to send information to more than one destination using a single message or packet. The broadcast domain 206 includes more than one port (shown as 222/223) identified by a unique port identifier (shown as 224/225). It is noteworthy that ports can be added or removed from the broadcast domain.

The broadcast domain 206 is associated with a subnet 210 identified by a unique name 212 with a default gateway 214. Subnet 210 is a logical, visible portion of an IP network. All network devices of a subnet are addressed with a common, identical, most-significant bit-group in their IP address. This results in the logical division of an IP address into two fields, a network or routing prefix and a host identifier that identifies a network interface. The subnet 210 has an IP address range 216 with a starting addressing and an address count 220. A gateway address 214 is also assigned to the subnet 210. The gateway address 214 is used by a computing device within the subnet 210 for routing information.

Layout 200 includes a logical interface (LIF) 226 that is identified by a unique and uses at least one port 222. LIF 226 includes an external IP address 230 by which clients connect to the clustered storage system. The IP address 230 may be static or dynamic.

Each Vserver 232 is associated with a LIF 226. The Vserver 232 is presented to the client 104 that uses the LIF 226 to communicate with the clustered storage system.

FIG. 2B shows a process 240 for generating global routing data structure 123 and routing data structure 105, according to one aspect. The process begins in block B242, when management console 122 is operational and initialized. One or more cluster node is also initialized and operational. In block B244, a user (for example, a storage administrator) using management console 122 at a computing device, generates a global routing data structure 123 (FIGS. 1A/1B) for a Vserver. In one aspect, management application 121 provides a graphical user interface (GUI) or command line interface (CLI) for creating the global routing data structure 123. An example of the global routing data structure 123 is provided below:

| Vserver | Destination | Gateway | Metric |
|---|---|---|---|
| Vserver 128.1 | 0.0.0.0/0 | 10.98.10.1 | 20 |
| | 0.0.0.0/0 | 10.98.112.1 | 20 |
| | 0.0.0.0/0 | 10.98.224.1 | 20 |

In the foregoing example, the user enters multiple default routes under the column labeled “destination” shown as 0.0.0.0/0. The multiple default routes are used throughout cluster 102. The user also adds a gateway address for each default route. The “metric” value is used to indicate a weight of a route, if there are multiple valid routes for a given LIF. The metric value may be used as a tiebreaker for multiple valid routes. If the metric value is the same, then any one of the routes may be selected, otherwise, the route with the lowest metric value is selected.

Once the global routing data structure 123 is generated, the user does not have to perform any other tasks for managing routing information at the node level.

In block B246, the user creates a LIF for the Vserver 128.1. As an example, assume that the user creates three IP addresses, where each IP address operates as an independent LIF for Vserver 128.1. An example of the IP addresses and LIFs, may be:

| Vserver | LIF | IP address | Netmask |
|---|---|---|---|
| Vserver128.1 | test1 | 10.98.10.20 | 255.255.255.0 |
| Vserver128.1 | test2 | 10.98.112.20 | 255.255.255.0 |
| Vserver128.1 | test3 | 10.98.224.20 | 255.255.255.0 |

In the foregoing example, under the first column, a Vserver name is provided (shown as 128.1). The different LIF names are shown as test1, test2, test3. The IP address for each LIF is shown in the next column. The Netmask column provides the subnet mask associated with each IP address.

In block B248, the global routing data structure 123 and the LIFs created in block B246 are provided to each cluster node 108.1-108.3.

In block B250, the routing module 103 of each node examines each route in the global routing data structure 123 to generate the routing data structure 105 for each node. When a gateway of the route is on the same subnet as the LIF, then the route is added to the routing data structure 105. For example, any node that is hosting an IP address, for example, “10.98.10.20” will also have the route with gateway “10.98.10.1” installed; any node that is hosting IP address “10.98.112.20” will have the route with gateway “10.98.112.1” installed, and whichever node is hosting IP address “10.98.224.20” will have the route with gateway “10.98.224.1” installed. As an example, the routing data structure 105 for each node is on per Vserver and per sub-net basis. It is noteworthy that multiple LIFs may be a part of the same routing data structure for the same Vserver and sub-net.

In one aspect, routing data structure 105 includes a plurality of routing groups. The routing groups include a default destination address, a gateway address and a port address. The routing groups are used by the nodes for routing information.

The foregoing process allows a storage administrator to add create a single global routing data structure 123 with more than one default route. The routing module 103 at each node then adds the appropriate route to the routing data structure 105 for a particular node. Thus, the storage administrator does not have to create individual routing groups for each node and for each LIF.

In another aspect, the process blocks of FIG. 2B, enable each node to handle the routes associated with IP addresses. When an IP address is migrated from one node to another, the client system does not have to perform any tasks, because the nodes update the routing data structures using the process of FIG. 2B.

Storage System Node:

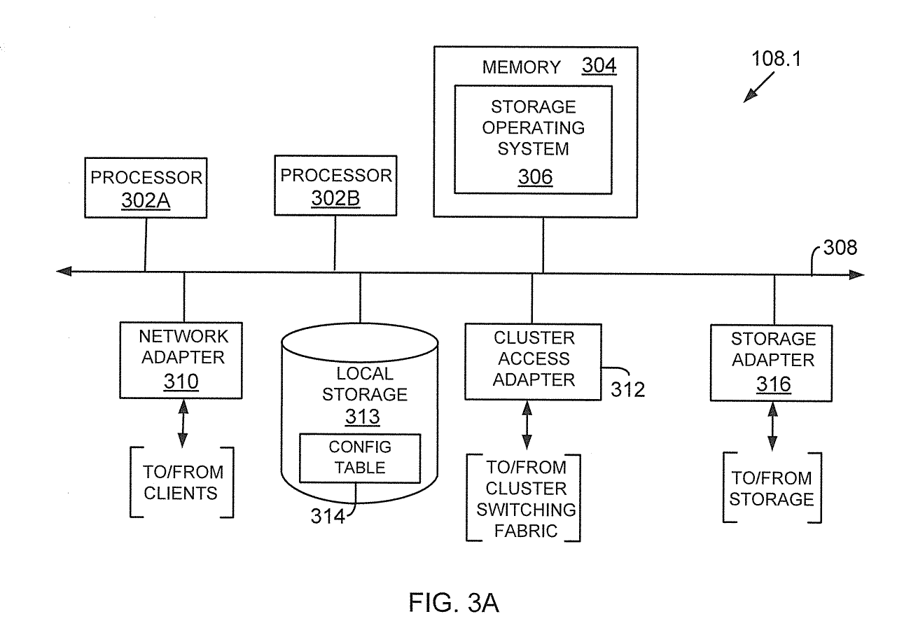

FIG. 3 is a block diagram of node 108.1 that is illustratively embodied as a storage system comprising of a plurality of processors 302A and 302B, a memory 304, a network adapter 310, a cluster access adapter 312, a storage adapter 316 and local storage 313 interconnected by a system bus 308. In one aspect, routing module 105 is executed by processor 302A, 302B or both by 302A and 302B.

Processors 302A-302B may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices. The local storage 313 comprises one or more storage devices utilized by the node to locally store configuration information for example, in a configuration data structure 314. In one aspect, the routing data structure 105 may be a part of the configuration data structure 314.

The cluster access adapter 312 comprises a plurality of ports adapted to couple node 108.1 to other nodes of cluster 100. In the illustrative aspect, Ethernet may be used as the clustering protocol and interconnect media, although it will be apparent to those skilled in the art that other types of protocols and interconnects may be utilized within the cluster architecture described herein. In alternate aspects where the N-modules and D-modules are implemented on separate storage systems or computers, the cluster access adapter 312 is utilized by the N/D-module for communicating with other N/D-modules in the cluster 100.

Node 108.1 is illustratively embodied as a dual processor storage system executing a storage operating system 306 that preferably implements a high-level module, such as a file system, to logically organize the information as a hierarchical structure of named directories and files on storage 112. However, it will be apparent to those of ordinary skill in the art that the node 108.1 may alternatively comprise a single or more than two processor systems. Illustratively, one processor 302A executes the functions of the N-module 114 on the node, while the other processor 302B executes the functions of the D-module 116.

The memory 304 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the presented disclosure. As an example, the routing data structure 105 may be stored at memory 304.

The storage operating system 306 portions of which is typically resident in memory and executed by the processing elements, functionally organizes the node 108.1 by, inter alia, invoking storage operation in support of the storage service implemented by the node.

The network adapter 310 comprises a plurality of ports adapted to couple the node 108.1 to one or more clients over point-to-point links, wide area networks, virtual private networks implemented over a public network (Internet) or a shared local area network. The network adapter 310 thus may comprise the mechanical, electrical and signaling circuitry needed to connect the node to the network. As an example, the network adapter 310 is similar to NIC 124, described above with respect to FIG. 1B.

The storage adapter 316 cooperates with the storage operating system 306 executing on the node 108.1 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored on storage device 112. The storage adapter 316 comprises a plurality of ports having input/output (I/O) interface circuitry that couples to the storage devices over an I/O interconnect arrangement, such as a conventional high-performance, FC link topology.

Operating System:

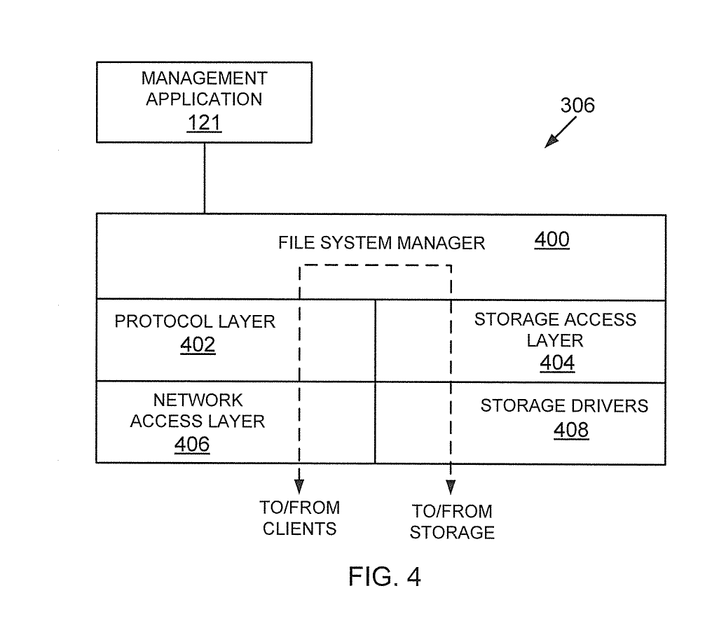

FIG. 4 illustrates a generic example of storage operating system 306 executed by node 108.1 interfacing with management application 121, according to one aspect of the present disclosure. Management application 121 sends the global configuration data structure 123 to the storage operating system 306 (for example, to network access layer 406, described below).

In one example, storage operating system 306 may include several modules, or “layers” executed by one or both of N-Module 114 and D-Module 116. These layers include a file system manager 400 that keeps track of a directory structure (hierarchy) of the data stored in storage devices and manages read/write operation, i.e. executes read/write operation on storage in response to client requests.

Storage operating system 306 may also include a protocol layer 402 and an associated network access layer 406, to allow node 108.1 to communicate over a network with other systems. Protocol layer 402 may implement one or more of various higher-level network protocols, such as NFS, CIFS, Hypertext Transfer Protocol (HTTP), TCP/IP and others, as described below.

Network access layer 406 may include one or more drivers, which implement one or more lower-level protocols to communicate over the network, such as Ethernet. Interactions between clients' and mass storage devices 112 are illustrated schematically as a path, which illustrates the flow of data through storage operating system 306.

The storage operating system 306 may also include a storage access layer 404 and an associated storage driver layer 408 to allow D-module 116 to communicate with a storage device. The storage access layer 404 may implement a higher-level storage protocol, such as RAID (redundant array of inexpensive disks), while the storage driver layer 408 may implement a lower-level storage device access protocol, such as FC or SCSI. The storage driver layer 408 may maintain various data structures (not shown) for storing information LUN, storage volume, aggregate and various storage devices.

As used herein, the term “storage operating system” generally refers to the computer-executable code operable on a computer to perform a storage function that manages data access and may, in the case of a node 108.1, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present disclosure may be utilized with any suitable file system, including a write in place file system.

Processing System:

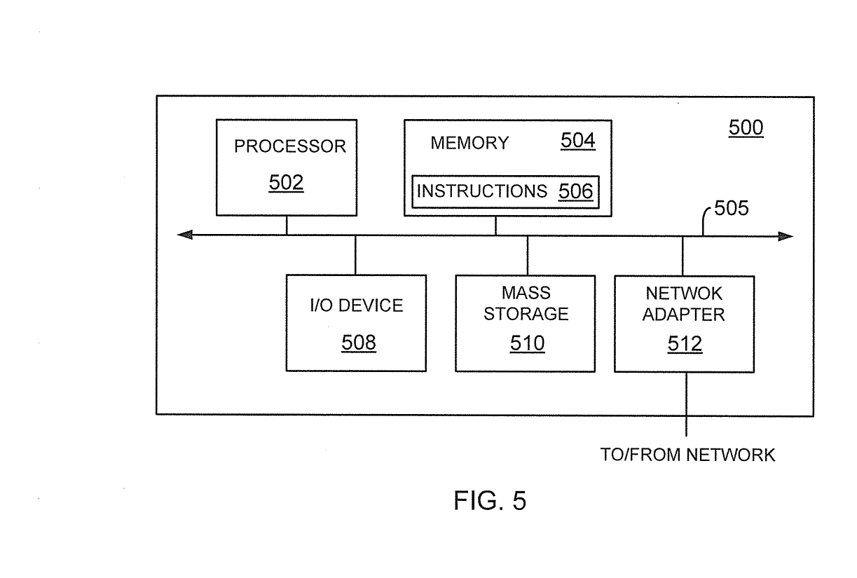

FIG. 5 is a high-level block diagram showing an example of the architecture of a processing system 500 that may be used according to one aspect. The processing system 500 can represent the management console 122 or client 104. Note that certain standard and well-known components which are not germane to the present disclosure are not shown in FIG. 5.

The processing system 500 includes one or more processor(s) 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 502 are the central processing units (CPUs) of the processing system 500 and, thus, control its overall operation. In certain aspects, the processors 502 accomplish this by executing software stored in memory 504. A processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 504 represents any form of random access memory (RAM), read-only memory (ROM), flash memory, or the like, or a combination of such devices. Memory 504 includes the main memory of the processing system 500. Instructions 506 implement the process steps described above with respect to FIG. 2B may reside in and executed (by processors 502) from memory 504.

Also connected to the processors 502 through the bus system 505 are one or more internal mass storage devices 510, and a network adapter 512. Internal mass storage devices 510 may be, or may include any conventional medium for storing large volumes of data in a non-volatile manner, such as one or more magnetic or optical based disks. The network adapter 512 provides the processing system 500 with the ability to communicate with remote devices (e.g., storage servers) over a network and may be, for example, an Ethernet adapter, a Fibre Channel adapter, or the like.

The processing system 500 also includes one or more input/output (I/O) devices 508 coupled to the bus system 505. The I/O devices 508 may include, for example, a display device, a keyboard, a mouse, etc.

Cloud Computing:

The system and techniques described above are applicable and useful in the upcoming cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” as used herein refers to a network (for example, the Internet) that is used for providing computing as a service.

Typical cloud computing providers deliver common business applications online (via the Internet or any other network) which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud.

After the application layer, is a cloud platform and cloud infrastructure, followed by a “server” layer that includes hardware and computer software designed for cloud specific services. The storage provider 116 (and associated methods thereof) and storage systems described above can be a part of the server layer for providing storage services. Details regarding these layers are not germane to the inventive aspects.

Thus, methods and systems for setting up routing in a clustered storage system have been described. Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A machine implemented method, comprising:
generating a global routing data structure having a plurality of default routes for a clustered storage system having a plurality of nodes;
creating a logical interface for a virtual storage system presented to a client system for using storage space at the clustered storage system managed by one of the plurality of nodes;
examining the global routing data structure by the plurality of nodes for adding a route for the logical interface when a gateway address of the route is on a same subnet as the logical interface; and
storing the route in a routing data structure for the node that manages the logical interface for the virtual storage system.

2. The machine implemented method of claim 1, wherein the global routing data structure is generated by a management application executed by a management console.

3. The method of claim 2, wherein the global routing data structure is provided to the plurality of nodes by the management application.

4. The method of claim 1, wherein the logical interface includes a network access address and the routing data structure stores the route associated with the network access address.

5. The method of claim 4, wherein the network access address is an Internet Protocol (IP) address.

6. The method of claim 4, wherein when the IP address is migrated to another node, then the another node generates a routing data structure without any interaction with a management application that generates the global routing data structure.

7. The method of claim 1, wherein a processor executable routing module at each node generates its own routing data structure, based on the global routing data structure.

8. A non-transitory, machine readable storage medium having stored thereon instructions for performing a method, comprising machine executable code which when executed by at least one machine, causes the machine to:
generate a global routing data structure having a plurality of default routes for a clustered storage system having a plurality of nodes;
create a logical interface for a virtual storage system presented to a client system for using storage space at the clustered storage system managed by one of the plurality of nodes;
examine the global routing data structure by the plurality of nodes for adding a route for the logical interface when a gateway address of the route is on a same subnet as the logical interface; and
store the route in a routing data structure for the node that manages the logical interface for the virtual storage system.

9. The storage medium of claim 8, wherein the global routing data structure is generated by a management application executed by a management console.

10. The storage medium of claim 9, wherein the global routing data structure is provided to the plurality of nodes by the management application.

11. The storage medium of claim 8, wherein the logical interface includes a network access address and the routing data structure stores the route associated with the network access address.

12. The storage medium of claim 11, wherein the network access address is an Internet Protocol (IP) address.

13. The storage medium of claim 11, wherein when the IP address is migrated to another node, then the another node generates a routing data structure without any interaction with a management application that generates the global routing data structure.

14. The storage medium of claim 8, wherein a processor executable routing module at each node generates its own routing data structure, based on the global routing data structure.

15. A system comprising:
a memory containing machine readable medium comprising machine executable code having stored thereon instructions; and a processor module coupled to the memory, the processor module configured to execute the machine executable code to:
generate a global routing data structure having a plurality of default routes for a clustered storage system having a plurality of nodes;
create a logical interface for a virtual storage system presented to a client system for using storage space at the clustered storage system managed by one of the plurality of nodes;
examine the global routing data structure by the plurality of nodes for adding a route for the logical interface when a gateway address of the route is on a same subnet as the logical interface; and
store the route in a routing data structure for the node that manages the logical interface for the virtual storage system.

16. The system of claim 15, wherein the global routing data structure is generated by a management application executed by a management console.

17. The system of claim 16, wherein the global routing data structure is provided to the plurality of nodes by the management application.

18. The system of claim 14, wherein the logical interface includes a network access address and the routing data structure stores the route associated with the network access address.

19. The system of claim 18, wherein the network access address is an Internet Protocol (IP) address.

20. The system of claim 19, wherein when the IP address is migrated to another node, then the another node generates a routing data structure without any interaction with a management application that generates the global routing data structure.

21. The system of claim 15, wherein a processor executable routing module at each node generates its own routing data structure, based on the global routing data structure.
